(19) United States
(12) Patent Application Publication
(10) Pub. No.: US 2020/0143451 A1
(43) Pub. Date: May 7, 2020

(54) REAL-TIME LOCATION AND COMMUNICATIONS SYSTEM

(71) Applicant: Long Range Systems, LLC, Richardson, TX (US)

(72) Inventors: John Weber, Richardson, TX (US); Mara Ghisani-rich, Richardson, TX (US); Syed Faisal Ali, Richardson, TX (US)

(21) Appl. No.: 16/671,135

(22) Filed: Oct. 31, 2019

Related U.S. Application Data
(60) Provisional application No. 62/754,505, filed on Nov. 1, 2018.

(51) Int. Cl. G06Q 30/06; G06Q 20/32; H04W 4/029; H04W 68/02

(52) U.S. Cl. CPC G06Q 30/0635; G06Q 20/3224; G06Q 50/12; H04W 68/02; H04W 4/029

(57) ABSTRACT

A real-time location and communications system may provide two-way communication in real-time between and among personal mobile devices and/or borrowed devices as well as fixed communication points and/or assets. The real-time location and communications system may be utilized to accept and provide on-premises service or ordering in real-time, as well as request and receive assistance in real-time. A push-for-service mechanism may be incorporated in a device that is associated with a user and may locate that user based on the location of the device. The user may be located in real-time both inside of a location and near the location. The location of the user may be updated in real-time when the user is mobile.

### CROSS-REFERENCE TO RELATED APPLICATION

This Application claims priority to U.S. Provisional Application No. 62/754,505 entitled “Real-Time Location and Communications System,” filed on Nov. 1, 2018, which is hereby incorporated by reference for all purposes.

### TECHNICAL FIELD

The disclosure relates generally to a real-time location and communications system, and more specifically, to a real-time location and communications system including personal mobile devices and/or borrowed devices that provide two-way communication.

### BACKGROUND

Some restaurants, retail stores, and other business utilize a service method in which customers place an order at a central service counter or from a kiosk, and then wait for their order to be fulfilled. For example, in a restaurant, customers may give their names to a server at the central counter, or the server may give each customer a number that will be called when the customer's food is ready. In either case, when the order is ready, a public address (PA) system may be used to call out the name or number of the customer associated with the order. The called customer then proceeds to the central counter and picks up his/her order. A disadvantage of the central service counter method is that many noisy PA system announcements must be made within the restaurant, thereby making the restaurant a less pleasant place to eat.

Some restaurants using the central service counter method eliminate the need to make noisy announcements by mounting paging receivers on tables or providing mobile pagers throughout the restaurant and providing the customer with a data token that includes an encoded customer identifier. Paging receivers, however, can have the disadvantage that the restaurant staff must maintain and, if necessary, repair them. Batteries must be regularly replaced, and the paging receivers are susceptible to damage by customers.

In restaurants with sit-down service, customers often have to wait in a waiting area or lounge for a table to become available before they can sit down and order their food from a waiter. Some of these restaurants utilize an on-premises paging system to alert waiting customers when their table is available. When the customer first arrives at the restaurant, he is given an on-premises pager by the receptionist who then enters the code number of the pager into the on-premises paging system. When the customer's table is available, an on-premises paging transmitter pages the customer's pager with the proper code number, and the customer is alerted. When not in use, these pagers are stacked on a recharging base, thus eliminating the need for restaurant staff to change batteries.

In other restaurants having takeout operations, customers waiting for their food orders must remain in the area of the food service counter so that a restaurant staff member can notify them when their order is ready. This is normally done verbally.

### SUMMARY

Embodiments of the present disclosure may provide a real-time location and communications system that may include a mobile device configured to transmit an order or request for service and provide a signal to aid in the determination of a location of a user, and at least one additional device configured to communicate in real-time with the mobile device to accept the order or request for service and track the location of the user. The mobile device and the at least one additional device may be personal mobile devices or borrowed devices. Personal mobile devices may be configured to transmit a unique identifier and a general-purpose but repeated radio frequency (RF) signal. Borrowed devices may be configured to communicate in real-time with personal mobile devices, other borrowed devices, and/or other assets to accept the order or request for service and track the location of the user. The system may include one or more fixed communication points or assets. Personal mobile devices may be selected from the group comprising: mobile phones, tablets, wearables, personal computers, and additional electronic devices. Borrowed devices may be selected from the group comprising: pagers, table tents, mobile phones, tablets, wearables, personal computers, and additional electronic devices. The at least one additional device may be configured to communicate in real-time with the mobile device over at least one of the following: a partner cloud, a global positioning system (GPS) system cloud, a server, a power over Ethernet (POE), a POE switch, a wireless network, Bluetooth low energy (BLE), ultra-wideband (UWB), and 5G cell networks. The mobile device and/or the at least one additional device may include a push for service (PFS) mechanism.

Other embodiments of the present disclosure may provide a method of communicating in real-time that may include placing an order or request for service on a personal mobile device. The method may provide updating a location of a user of the personal mobile device in real-time and transmitting the order or request for service and the location of the user to the at least one additional device in real-time. The location may be an indoor location, an outdoor location, and combinations of indoor and outdoor locations. Payments also may be made on the personal mobile device. One or more notifications may be received on the personal mobile device. Updating the location of the user may include assigning an identification to associate the order or request for service and the location. The personal mobile device may include a push for service (PFS) mechanism to accept or transmit requests. The personal mobile device may be selected from the group comprising: mobile phones, tablets, wearables, personal computers, and additional electronic devices. Transmitting the order or request for service and the location of the user to at least one additional device in real-time may be performed over at least one of the following: a partner cloud, a global positioning system (GPS) system cloud, a server, a power over Ethernet (POE), a POE switch, a wireless network, Bluetooth low energy (BLE), ultra-wideband (UWB), and 5G cell networks.

Additional embodiments of the present disclosure may provide a real-time location and communications system that may provide two-way communication between personal mobile devices, borrowed devices, and/or other assets. The system may allow requests for assistance to be transmitted, received, and fulfilled via the personal mobile devices and/or the borrowed devices.

Other technical features may be readily apparent to one skilled in the art from the following drawings, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 depicts a communication system according to an embodiment of the present disclosure;

FIG. 2A is a screenshot displaying a real-time location and communications system according to an embodiment of the present disclosure;

FIG. 2B is another screenshot displaying a real-time location and communications system according to an embodiment of the present disclosure;

FIG. 2C is an additional screenshot displaying a real-time location and communications system according to an embodiment of the present disclosure;

FIG. 2D is a screenshot displaying a real-time location and communications system according to an embodiment of the present disclosure;

FIG. 2E is another screenshot displaying a real-time location and communications system according to an embodiment of the present disclosure; and

FIG. 2F is an additional screenshot displaying a real-time location and communications system according to an embodiment of the present disclosure.

### DETAILED DESCRIPTION

Embodiments of the present disclosure may generally provide a real-time location and communications system.

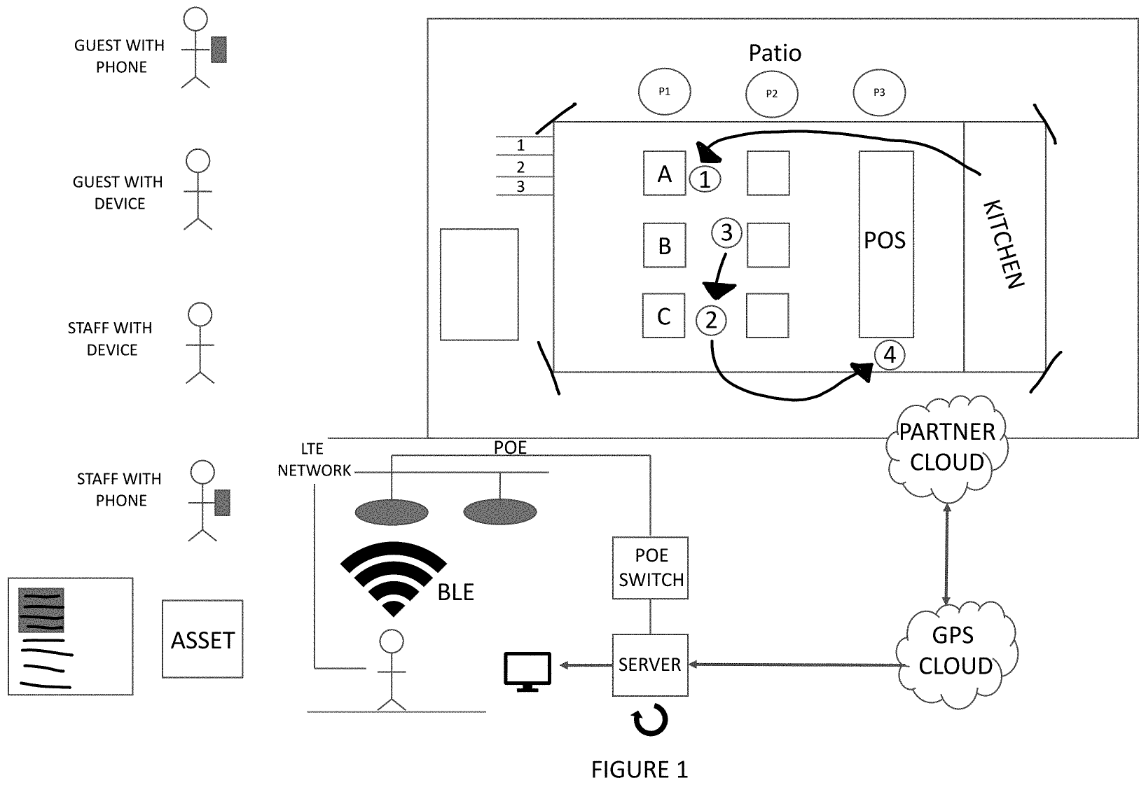

FIG. 1 depicts real-time location and communication system 100 according to an embodiment of the present disclosure. Real-time location and communications system 100 may include one or more personal devices and/or one or more borrowed devices. Other fixed communication points and/or assets also may be incorporated into system 100 without departing from the present disclosure. For example, real-time location and communications system 100 may include a personal device(s) that may place or receive an order or request, such as a request for service. The personal device(s) may communicate the order or the request to a borrowed device(s) within a location. The borrowed device(s) may also communicate with the personal device(s) and may respond to requests for assistance. Similarly, a borrowed device(s) may communicate an order or request to a personal device(s) in embodiments of the present disclosure.

It should be appreciated any quantity of personal devices and borrowed devices may be utilized without departing from the present disclosure. It should also be appreciated that personal devices may include, but are not limited to, mobile phones, tablets, wearables, personal computers, and additional electronic devices without departing from the present disclosure. It should further be appreciated that borrowed devices may include, but are not limited to, pagers, table tents, mobile phones, tablets, wearables, personal computers, and additional electronic devices without departing from the present disclosure. It should be appreciated that the location may be a restaurant, retail store, classroom, hospital, office building, parking lot, and other locations.

Real-time location and communications system 100 may further include a partner cloud, a global positioning system (GPS) cloud, a server, power over Ethernet (POE), a POE switch, a wireless network, Bluetooth low energy (BLE), and/or other similar or related technologies either known or unknown including, but not limited to, ultra-wideband (UWB) and 5G cell networks that may facilitate real-time communication between and among personal devices, borrowed devices, fixed communication points and/or assets in embodiments of the present disclosure. It should be appreciated that more or fewer components or any combination of components including, but not limited to, the above-mentioned components may be utilized in real-time location and communications system 100. It should be appreciated that real-time location and communications system 100 may be utilized with messaging applications, electronic mail, paging systems, and/or other communication platforms that may reside on or be utilized with, for example, a personal device or borrowed device in embodiments of the present disclosure.

Real-time location and communications system 100 may provide one or more personal devices that may include an application, such as mobile app, that may permit a user to place an order, make payment, make requests, and/or receive notifications. Similarly, one or more personal devices may accept an order from a user, receive/process payment. While personal devices, such as a personal mobile devices, may be used within system 100, it should be appreciated that there may be embodiments wherein borrowed devices may be utilized by customers/users and/or service providers as discussed below.

For example, a borrowed device may be handed to the customer/user by the service provider upon the completion of an order being placed, whether through a fixed communication point, placing an order with a live service provider, or through a personal device. It should be appreciated that orders may be placed via a kiosk or by utilizing a device that may not be live and/or mobile without departing from the present disclosure. The borrowed device may allow the service provider to track the customer/user; however, again, there may be embodiments of the present disclosure where the customer/user may be tracked using his/her personal device. Real-time location and communications system 100 may allow the service provider to track, locate, and/or observe displacement of the user/customer in real-time. It should be appreciated that the location of the customer/user and the service provider may be available in real-time on the borrowed devices, through a personal device, on a fixed monitor or display on or off premises, and/or on additional platforms. It should be appreciated that requests for assistance may be transmitted, received, and/or fulfilled via devices including, but not limited to, personal mobile devices, borrowed devices, displays, computers, and other types of devices.

Service providers may include, but are not limited to, wait staff, restaurant personnel, hospital staff, classroom instructors, delivery personnel, and other service members. The service providers may utilize the location of the user to deliver an order, provide a service, fulfill a request, provide notifications, and/or to generally increase efficiency. For example, in a classroom, students may each possess a personal device or a borrowed device, and the instructor may possess a personal device or a borrowed device. Real-time location and communications system 100 may access the students' personal devices to determine the location of each student and whether seat selection is correlated to student performance. Real-time location and communications system 100 may notify the instructor via his/her personal or borrowed device to move a particular student(s) to a different seat in order to help improve student performance.

The borrowed or personal device associated with a user may include a mechanism, such as a button or a screen image/icon, that the user may select to request service or assistance. In some embodiments of the present disclosure, the user may receive service or assistance through his/her personal or borrowed device. Real-time location and communications system 100 may track the user in real-time at any location inside of an area or nearby. For example, the location of the user inside of a retail location, a restaurant, on the patio, in a vehicle parked or moving outside of the restaurant, and other nearby locations may be tracked in real-time.

Real-time location and communications system 100 may automatically assign a number or request identification by the personal device that may be tied to an order and/or request of the user and facilitate on-premises ordering and delivery of assistance and/or goods and/or services. It should be appreciated that each personal device, borrowed device, or user may be assigned a unique identifier. Personal and borrowed devices may provide built-in Bluetooth or another similar communication protocol and may be carried by hand and/or mounted in embodiments of the present disclosure. Communication and location capabilities may be associated with personal devices, borrowed devices, fixed communication points, and/or assets by utilizing radio frequency (RF), ultra-high frequency (UHF) transmitters and/or receivers, and/or Bluetooth low energy (BLE) transmitters and/or receivers. However, other communication protocols may be utilized without departing from the present disclosure.

A personal device, borrowed device, and/or a fixed communication point may include a push for service (PFS) mechanism that may accept and transmit requests from a fixed and known location on-premises or nearby the location. A real-time locating system (RTLS) may map user and/or service provider location in real-time. It should be appreciated that the RTLS may be applied to locating assets without departing from the present disclosure. A software development kit (SDK) may be present on a device that may allow a user and/or service provider to be tracked in real-time on-premises, either indoors or nearby. One or more purpose-built devices in the possession of other service providers may provide real-time indoor or nearby location of fellow service providers. The one or more purpose-built devices may or may not provide additional communication capability including, but not limited to, an alpha pager.

Personal and borrowed devices may automatically include real-time location and communications system 100 that may be native to the personal and borrowed devices and/or operating systems associated with the personal and borrowed devices. Real-time location and communications system 100 may automatically track the location of the user by utilizing heat maps and may make recommendations for more efficient placement and arrangement of items inside of the location, such as, furniture, equipment, restrooms, etc. It should be appreciated that real-time location and communications system 100 may track and compile real-time and historical location and user/service provider positional information. Trends related to location on-premises and nearby user/service provider positional information may provide recommendations for improved venue interaction and engagement that may improve design and construction of current and future locations, for example.

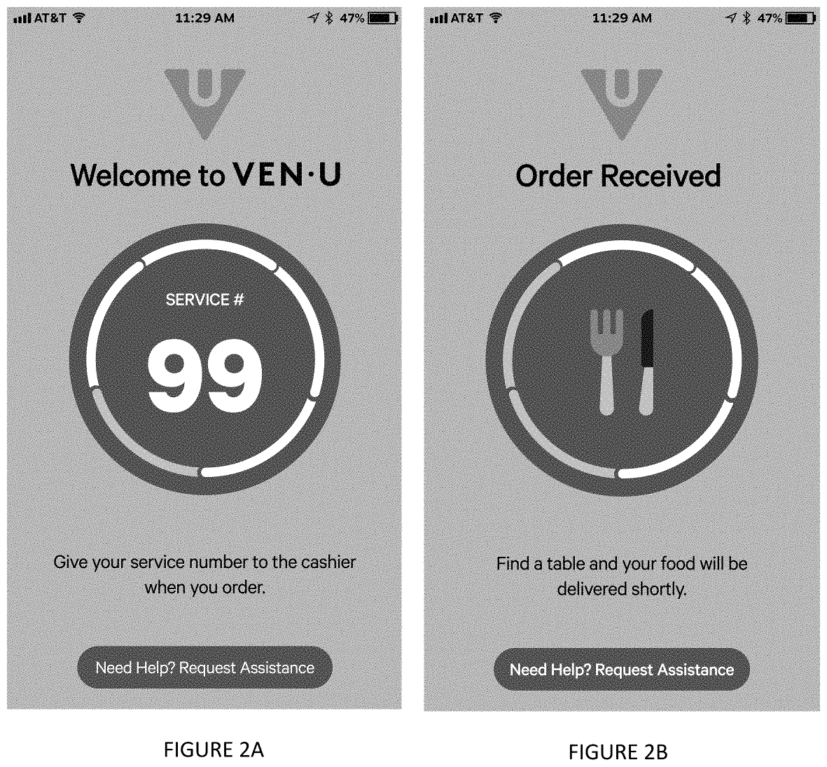

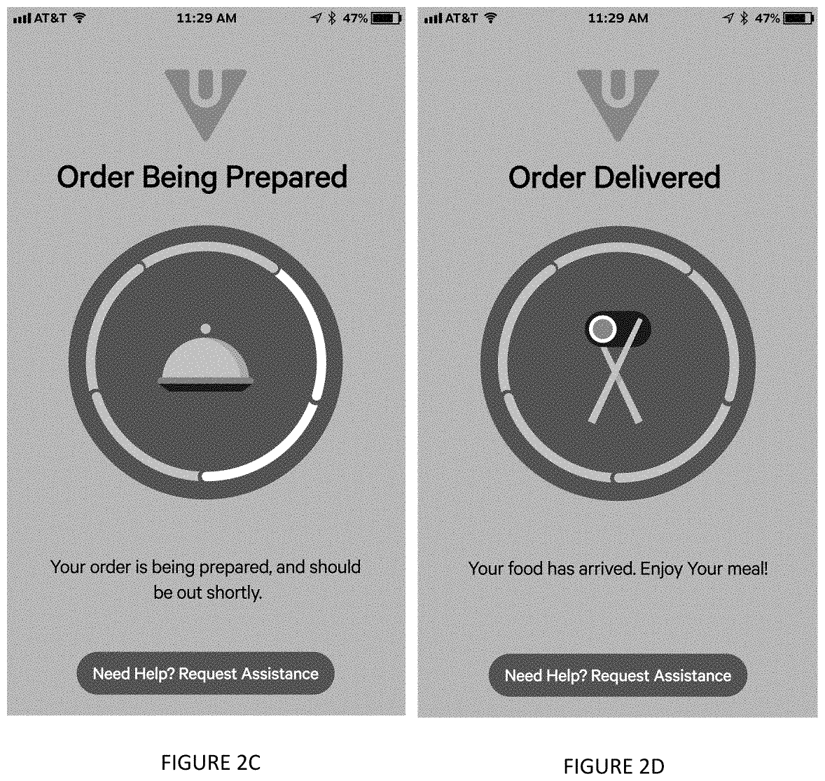

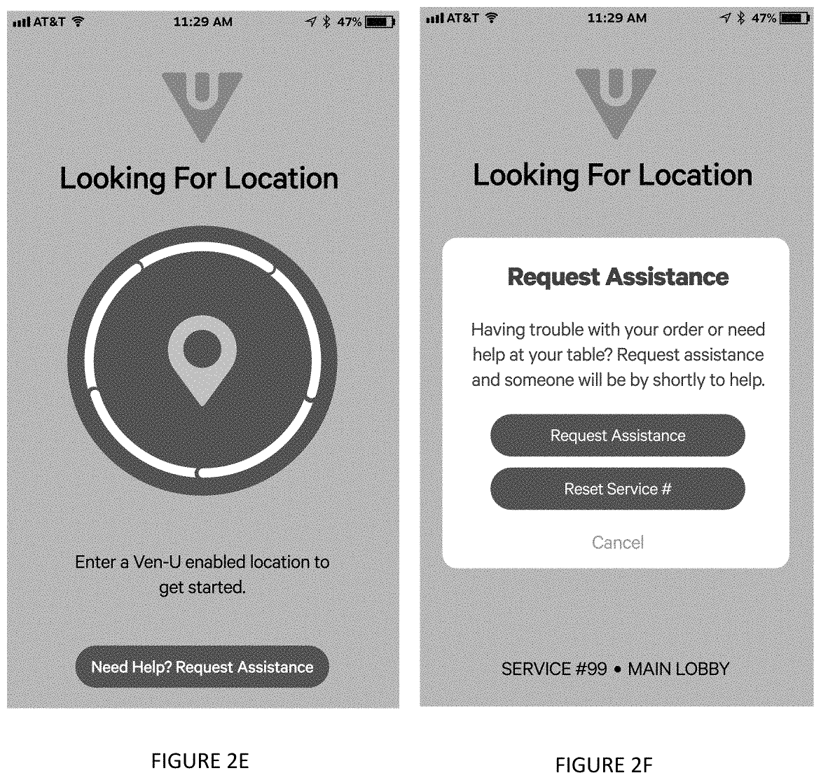

FIGS. 2A-2F depict screenshots of real-time location and communications system 100 according to an embodiment of the present disclosure. A user may utilize a personal device or a borrowed device that may include an application to place an order. The user may be presented with a service number that may allow updates including, but not limited to, “Order Received,” “Order Being Prepared,” and “Order Delivered” that may be provided to the user communicating an order status. The user may request assistance, reset the service, and/or cancel an order from his/her personal device or borrowed device. Service providers may track the user and the order based on the service number. Real-time location and communications system 100 may be provided in the foreground of an application that may be displayed on the personal device and/or the borrowed device. Content or notifications that may be relevant to the user may be displayed on the personal device and/or the borrowed device. Content or notifications may include, but are not limited to, advertisements, sales, suggestions for future orders, expected delivery time, expected wait time, suggested seats in a venue, instructions, and additional information. It should be appreciated that real-time location and communications system 100 may automatically present the user of the personal device and/or the borrowed device with content related to objects that may be in close proximity of the user in embodiments of the present disclosure. For example, in a retail store, the personal device and/or the borrowed device may display an advertisement or the price of an item that may be located within three feet of the user.

It should be appreciated that real-time location and communications system 100 may save space or real estate within an establishment by not requiring kiosks, large displays, installation of additional equipment within the establishment, or counters where customers may place orders. Real-time location and communications system 100 may increase a capacity of customers that can be accommodated and served by automatically tracking user location and orders in real-time. It should be appreciated that real-time location and communications system 100 may be utilized in various industries including, but not limited to, education/classroom, food services, hospital/medical, and other industries.

Real-time location and communications system 100 may manage waitlists and may send a single notification to everyone on the waitlist at one time and/or selectively send notifications to one or more persons on a list in embodiments of the present disclosure. Real-time location and communications system 100 may provide a capability of communicating with additional devices. For example, an asset, such as hospital crash cart, may be in communication with real-time location and communications system 100. Real-time location and communications system 100 may prevent assets from being lost or misplaced and may provide real-time tracking of assets.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A real-time location and communications system, comprising:
a mobile device configured to transmit an order or request for service and provide a signal to aid in the determination of a location of a user; and
at least one additional device configured to communicate in real-time with the mobile device to accept the order or request for service and track the location of the user,
wherein the mobile device and the at least one additional device are personal mobile devices or borrowed devices.

2. The system of claim 1 further comprising:
one or more fixed communication points or assets.

3. The system of claim 1, wherein personal mobile devices are selected from the group comprising:
mobile phones, tablets, wearables, personal computers, and additional electronic devices.

4. The system of claim 1, wherein borrowed devices are selected from the group comprising:
pagers, table tents, mobile phones, tablets, wearables, personal computers, and additional electronic devices.

5. The system of claim 1, wherein the at least one additional device is configured to communicate in real-time with the mobile device over at least one of the following:
a partner cloud, a global positioning system (GPS) system cloud, a server, a power over Ethernet (POE), a POE switch, a wireless network, Bluetooth low energy (BLE), ultra-wideband (UWB), and 5G cell networks.

6. The system of claim 1, wherein the mobile device and/or the at least one additional device include a push for service (PFS) mechanism.

7. A method of communicating in real-time, comprising:
placing an order or request for service on a personal mobile device;
updating a location of a user of the personal mobile device in real-time, wherein the location is an indoor location, an outdoor location, and a combination of outdoor and indoor locations; and
transmitting the order or request for service and the location of the user to at least one additional device in real-time.

8. The method of claim 7 further comprising:
making payment on the personal mobile device.

9. The method of claim 7 further comprising:
receiving one or more notifications on the personal mobile device.

10. The method of claim 7, wherein updating the location of the user includes assigning an identification to associate the order or request for service and the location.

11. The method of claim 7, wherein the personal mobile device includes a push for service (PFS) mechanism to accept or transmit requests.

12. The system of claim 7, wherein the personal mobile device is selected from the group comprising:
mobile phones, tablets, wearables, personal computers, and additional electronic devices.

13. The system of claim 7, wherein transmitting the order or request for service and the location of the user to at least one additional device in real-time is performed over at least one of the following:
a partner cloud, a global positioning system (GPS) system cloud, a server, a power over Ethernet (POE), a POE switch, a wireless network, Bluetooth low energy (BLE), ultra-wideband (UWB), and 5G cell networks.
